(19) United States
(12) Patent Application Publication
(10) Pub. No.: US 2009/0151096 A1
(43) Pub. Date: Jun. 18, 2009

(54) TUBE SCRAPING DEVICE

(76) Inventor: Jean-Michel Bideault, Pierrelaye (FR)

Correspondence Address: WINSTON & STRAWN LLP;PATENT DEPARTMENT, 1700 K STREET, N.W., WASHINGTON, DC, 20006, US

(21) Appl. No.: 12/336,109

(22) Filed: Dec. 16, 2008

(30) Foreign Application Priority Data
Dec. 17, 2007 (FR) 07 59912

(51) Int. Cl. B08B 1/00

(52) U.S. Cl. 15/104.04

(57) ABSTRACT

The invention relates to a tube scraping device including a body having means for scraping the tube, and driving means for driving said body in rotation about the tube. The body is equipped with pivoting jaws. A part of the driving means is borne by a driving structure independent from the body.

### FIELD OF THE INVENTION

The invention relates to a device for scraping a tube.

The invention relates to plastic tubes, in particular tubes for supplying a pressurized fluid (typically gas), in which it is recommended to scratch their external surface before assembling them.

### BACKGROUND OF THE INVENTION

Currently, an assembly comprising plastic tubes, adapted for supplying a pressurized fluid (typically gas) is issued from two independent tubes connected by electrical welding, in which the previous removal of an external oxidized surface film eroded by a scraper contributes to the quality of the welded junction.

There are numerous scraping devices. One objective in this case is to be able to quickly intervene, with an easy-to-use, compact apparatus.

### SUMMARY OF THE INVENTION

For providing a solution to at least some of the above-mentioned goals, the invention proposes a scraping tube device including:
a body adapted to rotate about a pivot pin to be arranged parallel to an axis of the tube to be scraped, said body having two jaws adapted to rotate about said pivot pin between:
an open position enabling the body to be disposed around the tube and removed therefrom;
a closed position in which the jaws are closer to the tube than in the open position,
   said jaws including a first part of driving means adapted to drive said jaws in rotation about the tube while the jaws are in the closed position, and said body holding jaw maneuvering means, for moving said jaws from the open position to the closed position, and the reverse, and tube scraping means adapted to come into contact with an external surface of said tube with a view to scraping it, while said jaws are in the closed position, the scraping means being mounted so as to rotate with the body, and therefore with the jaws,

a second part of the driving means, said second part being adapted for engaging with the first part said driving means, with a view to causing, in an engaged position, said rotation of the jaws,

and rolling means mounted at an internal surface of the jaws, away from the scraping means, so as to cause said jaws to roll around an external surface of the tube, while said jaws are in the closed position.

It is important for the maneuvers of opening/closing the device to be practical and secure in their effect. The reliability and safety on an intervention site are essential.

It is also recommended that the aforementioned jaw maneuvering means include toggle means acting in coordination with spring means for the pivoting of the jaws between said stable open and closed positions.

Similarly, aid means for aiding the closing of the jaws are provided.

### BRIEF DESCRIPTION OF THE DRAWINGS

Other features and advantages of the solutions described here will appear in the following more complete description in reference to the appended drawings, in which:

FIG. 1 diagrammatically shows the pivoted body of the tool, with its two jaws and in this case a scraping blade (12a), with the assembly positioned around a tube to be scraped; the jaws are open,

FIG. 2 diagrammatically shows, from a bottom view, a second portion of the tool with a part (in this case powered) for driving the body in rotation about the tube,

FIG. 3 shows, from the front (cross-section perpendicular to the axis of the tube), the body of FIG. 1, with the jaws open,

FIG. 4 shows, also from the front, the body with the jaws closed, in the operational position, superimposed by the second (powered) part of the tool that drives it automatically in rotation about the tube,

FIG. 5 shows, from the side, the view of FIG. 4,

FIGS. 6 and 7 show in detail the cam for aiding the opening/closing of the jaws,

FIG. 8 shows in detail the meshing for driving the body in rotation, preferably provided on the powered part of the tool,

FIG. 9 shows in detail the manual means for driving the body in rotation, which can be used as a substitution for the powered part of FIG. 4,

FIGS. 10 and 11 also show in detail the meshing for driving the body in rotation, in particular the amplitude and the alternative angular to-and-fro movement, in the powered solution,

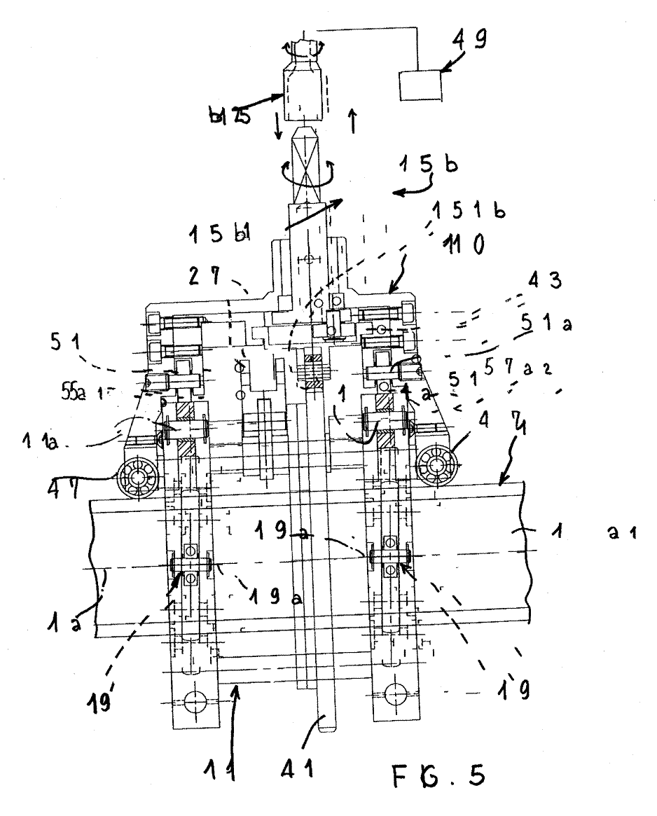

and FIGS. 12 and 13 show in detail, from a bottom view, a portion of the automatic control structure of FIG. 4, with its carriage that ensures the aforementioned to-and-fro movement.

It should be mentioned that, in the figures, all of the hidden lines are not necessarily shown as dotted lines. The reference arrows indicating the corresponding parts are shown with dotted lines.

### DETAILED DESCRIPTION OF THE PREFERRED EMBODIMENT

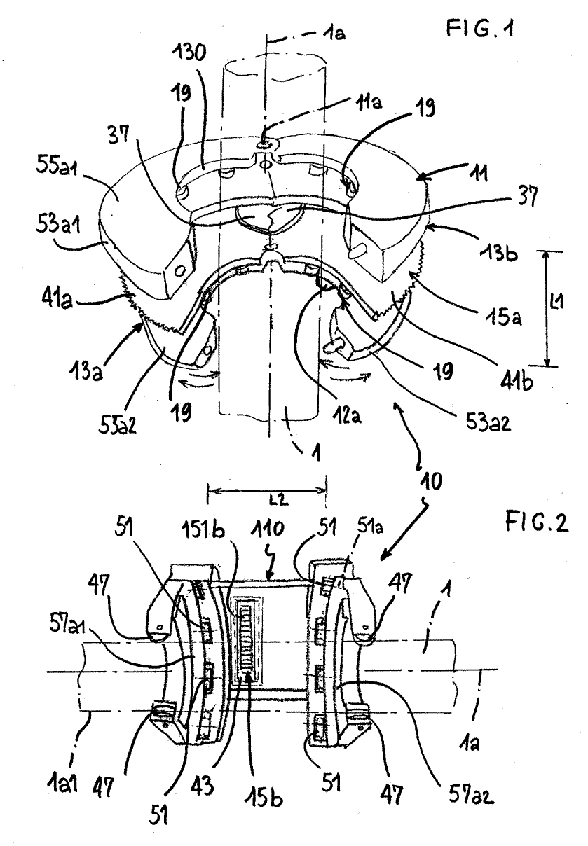

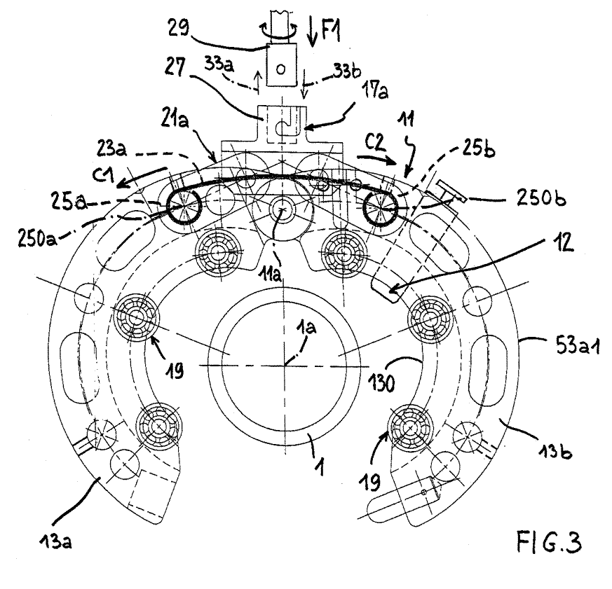

FIGS. 1 and 2 are shown from two different views of a device according to the invention for scraping a tube 1. It is a plastic tube, which can be polyethylene.

The scraping device 10 generally includes two parts:
a body 11 provided with at least one scraping blade 12a pivoting about a pivot pin 11a to be arranged parallel to the axis of the tube, which body thus has two jaws 13a, 13b adapted to rotate about said pivot pin,
and a second unit (or structure) 110 having a part 15b of the means 15a, 15b for driving the jaws, and therefore the scraping blade 12, in rotation, in which said driving part 15b is adapted for engaging with (from above) the first part 15a of these driving means mounted on the body 11.

Such a device is particularly adapted for remote use, on a pipeline in place. Typically, the intervention is performed from the top of an excavation, after the operator has exposed the immediate area of the duct and therefore removed the earth around it, for example an area of around 0.25 m².

It is first the body 11 that is lowered into the open excavation.

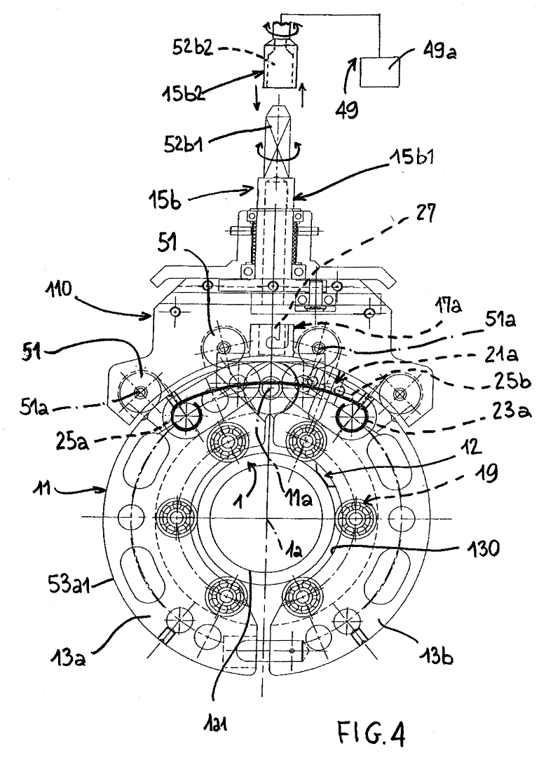

FIGS. 1 and 3 show it with its jaws 13a, 13b open, ready to close around the tube 1.

Indeed, these jaws can rotate about the pivot pin 11a between:
a(n) (stable) open position enabling the body 11 to be placed around the tube and removed therefrom,
and a (stable) closed position (FIG. 4) in which the jaws 13a, 13b are closer to the tube 1 than in the open position.

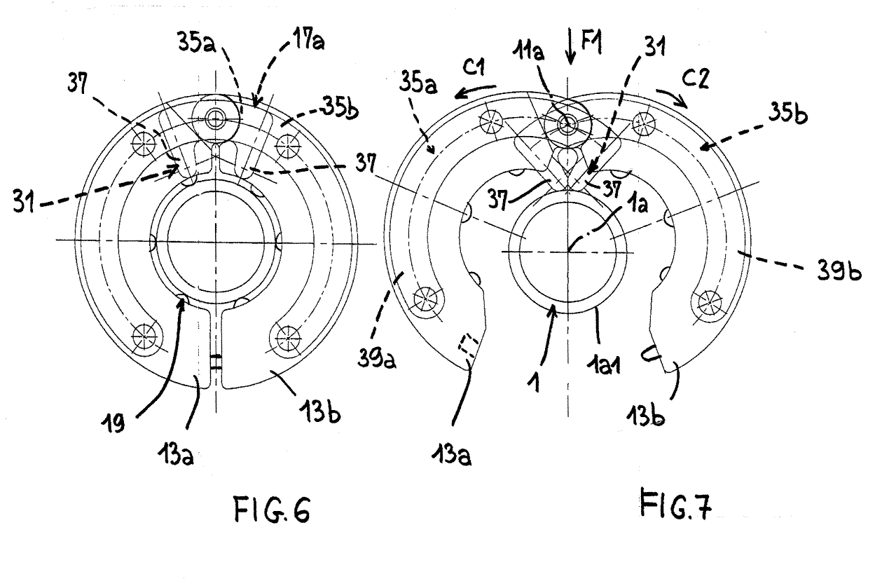

As indicated above, and shown in particular in FIGS. 4 and 5, the jaws include or bear the first part 15a of the means 15a, 15b provided for driving the jaws in rotation about the tube, while said jaws are in the closed position. To move these jaws from their open position to their closed position, and the reverse, the body 11 has means 17a for maneuvering the jaws (cf. FIGS. 3 and 4 in particular).

To erode the external surface 1a1 of the tube, the body 11 therefore also has means 12 for scraping the tube, which, while the jaws are in the closed position, come into contact with said surface 1a1 (FIG. 4).

The cutting blade of the scraping means 12 is preferably mounted so as to be adapted to move on return means (such as a spring) and its pivoting in the direction of the generatrix of the tube is allowed by a ball joint with a low range of movement in order to meet the residual curves thereof, while respecting a maximum radius of curvature. The thickness of the chip may vary preferably from 0.2 mm to 0.4 mm. advantageously, the removal of material from the tube will occur continuously and the width of the chip will correspond to the axial forward movement (1a) obtained when the tool 10 rotates, so as to avoid missing areas to be scraped and removal overlaps.

The scraping means are mounted so as to rotate with the body, and therefore with the jaws, when the latter are driven around the tube by the aforementioned means 15a, 15b, i.e. when the second part 15b of the driving means is engaged with the first part 15a.

For a movement without excessive friction of the jaws around the tube, rolling means 19 mounted at the internal surface 130 of the jaws, away from the scraping means 12, are also provided on the body 11, with a view to causing the jaws 13a, 13b to roll about the external surface 1a1 of the tube, while said jaws are in the closed position.

In particular, FIGS. 3 and 4 show that the jaw maneuvering means 17a borne by the body 11 include toggle means 21a acting in coordination with spring means 23a for pivoting the jaws between their stable open and closed positions.

In these figures, it is noted that these toggle means include two levers 25a, 25b. Each lever is pivotably connected to one of the jaws (pins 250a, 250b, FIG. 3). In addition, a maneuvering end part 27 is pivotably connected to each of these levers, so as to control them via a remote control rod 29 removably attached to the end part 27, in this case via a removable bayonet connection. The rod 29 can be maneuvered remotely by the operator, typically from the top of the excavation.

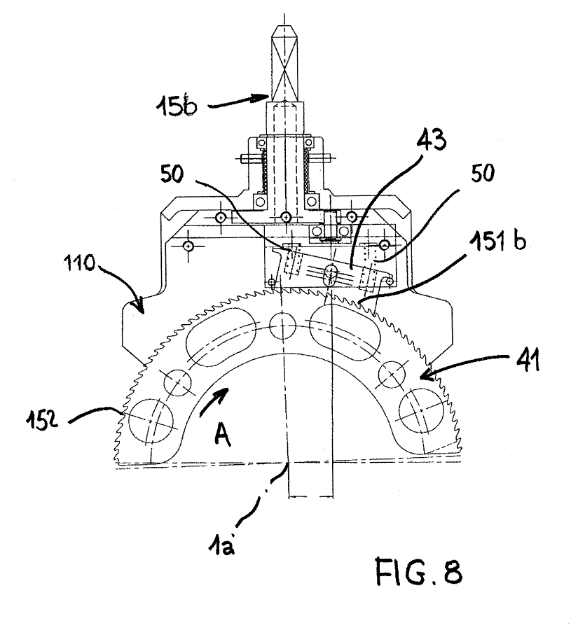

The assembly defines the main part of the aforementioned jaw maneuvering means 17a, which can advantageously be completed with aid means 31 for aiding the closing of said jaws, shown in FIGS. 6 and 7.

From FIGS. 3, 4, 6 and 7, it is understood that the opening of the jaws 13a, 13b of the body 11 is performed by pulling on the toggle means 21a (arrow 33a, FIG. 3), with the closing being performed in the reverse direction, by pushing (arrow 33b).

FIGS. 6 and 7 therefore show that the maneuvering means 17a include, as aid means 31 for aiding the closing of the jaws, two actuation members 35a, 35b, which are respectively attached to each of the jaws. These actuation members each have a nose 37 projecting from the internal surface of the jaws, when the latter are in the open position (FIG. 7). The noses are located so that two closing torques C1, C2 are created, in opposition, when the noses come into contact with the tube, resulting from a force F1 exerted for this purpose. It is noted that the noses are laterally offset beyond the pivot pin 11a, opposite the internal surface of the jaw complementary to that with which the member considered is attached in the location of its elongate portion (respectively 39a and 39b).

Thus, via means 27 and 29, a vertical contact according to F1 against the tube 1 will therefore create the opposing torques C1, C2, and thus the turning in the same direction of the jaws around the pin 11a. Even in the absence of aid means 31, FIG. 3 shows that the force F1 applied on the aforementioned contact (direct or not) of the jaws on the tube near the pin 11a, plumb over which means 17a extend, creates opposing torques C1, C2 and the closing of said jaws by pivoting movements of the levers 25a, 25b, which, beyond a balance point immediately moves the jaws toward a closed state, under the effect of the spring(s) (in this case a leaf spring) 23a mounted around the pins 250a, 250b and extending between them, perpendicularly to the pin 11a, above it, as shown.

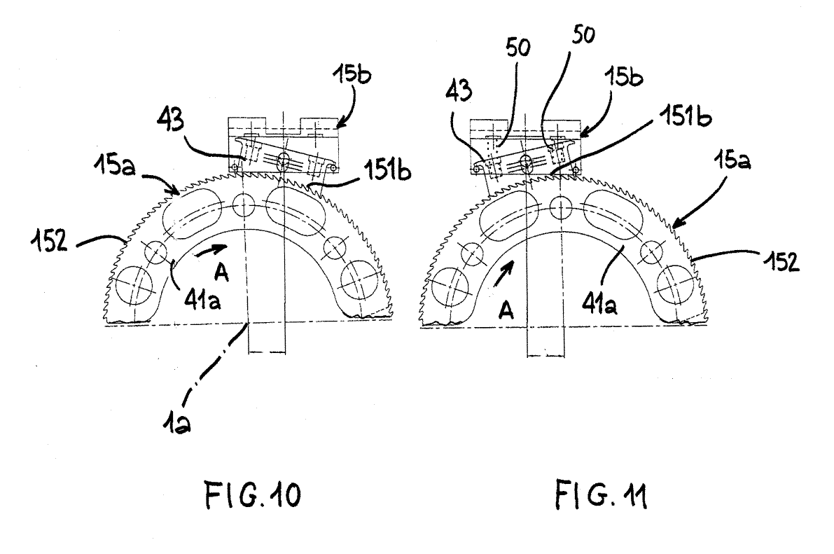

To drive the jaws, in the closed position, in rotation about the tube 1, various figures, and in particular FIGS. 4, 5, 8 and 9, show that it is possible to use either a manual (FIG. 9) or a powered (FIGS. 4, 5, 8) control, in this case adapted to be operated remotely, under the action of removable extensions.

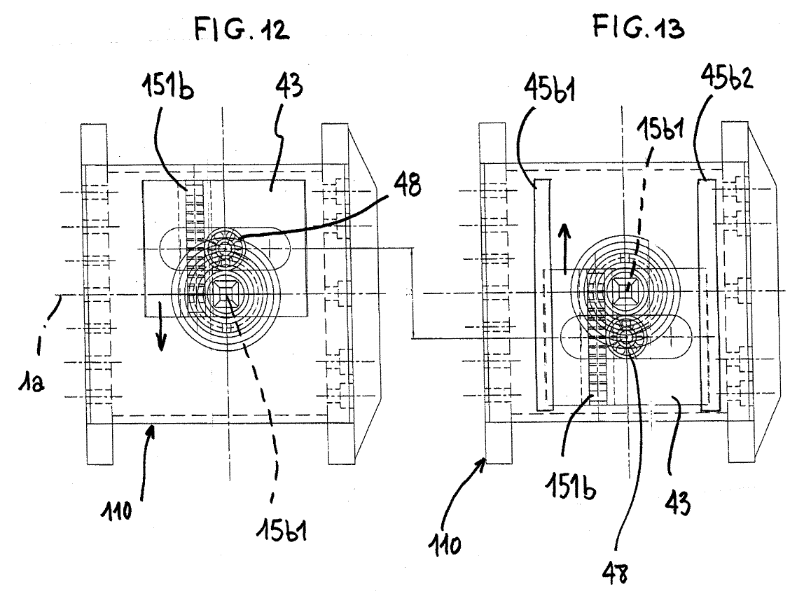

Before describing these controls in detail, it should be noted in particular with regard to FIGS. 1, 2, 4, 5, 8, 9, 10 and 11, that the first and second parts 15a, 15b (150b, FIG. 9) of the means for driving the jaws in rotation will preferably define a toothed driving system in which said parts mesh with one another.

To coordinate reliability, efficacy and simplicity, the first part of the means for driving the jaws in rotation in this case includes, according to the preferred solution shown, a crown 41 in two externally toothed parts 41a, 41b, pivoting one with respect to the other about the pivot pin 11a. Additionally, the second part 15b (150b, FIG. 9) of the driving means will preferably include:
either a line of teeth 151b (FIGS. 2, 5, 8, 10, 11) mounted on a carriage 43 adapted to move in translation substantially tangentially to the crown 41, in the engaged meshing position, thus defining a rack,
or one or more push bars 153b extending individually between two successive teeth of the crown 41 (FIG. 9).

In the latter case, FIG. 9 shows that the second part of the driving means is separable from the first part 15a and belongs to manual control means including a structure 150b1 bearing said second part of the driving means and an elongate rod 150b2 pivotably mounted (in 45, according to an axis parallel to that of the tube) on the bearing structure so that it can be pushed, while the first and second aforementioned parts 15a, 150b are in the inter-engaged position. Thus, it is possible to move one with respect to the other, and drive said scraping means 12 around the tube, by rotation of the crown 41, and therefore drive the jaws thus in their closed state around the tube.

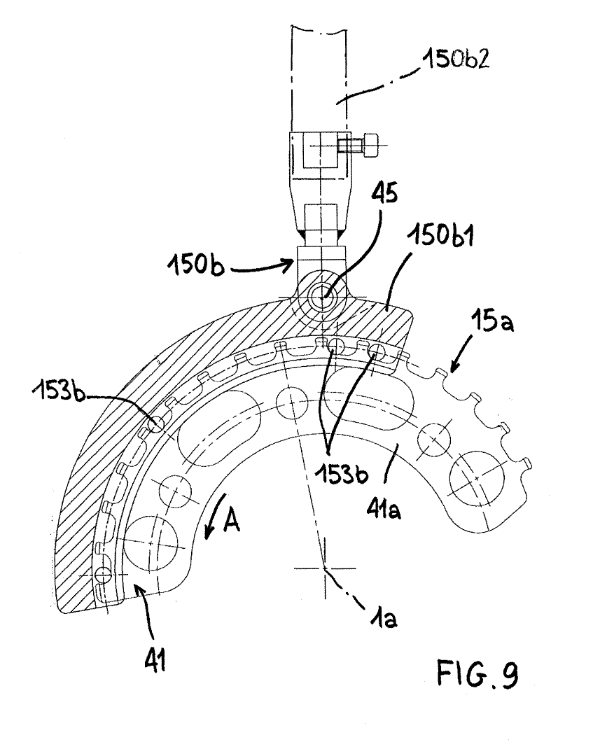

FIG. 9 shows that the structure 150b1, forming an arc of circle, securely holds the push bars 153b. The rod 150b2 can be removed from the structure 150b1. To produce the crown, the bars 153b are engaged in the recesses between teeth, and the assembly is pushed in direction A, for example to the left, from the top of the excavation via the rod 150b2. Once the scraping has ended, the rod is returned to a substantially vertical position and removed. The teeth of the crown are symmetrical and no longer slanted to one side as in FIGS. 8, 12 and 13.

In the other solution, a toothed segment 151b will be mounted so as to be adapted to move tangentially under the action of a power driving system, along teeth of the crown 41, transversally to the pivot pin 11a of the jaws. If it is provided, the carriage (43; FIGS. 2, 8-13) will preferably be moved in translation opposite the crown, in a plane perpendicular to that of said crown.

Again, the second part 15b (15b1) of the driving means will be separable from the first part 15a and will then belong to the powered control means.

In FIGS. 2 and 5, in particular, these control means include:
the aforementioned structure 110 bearing said second part 15b, 15b1 of the means for driving the jaws in rotation,
a first series 47 of wheels to be arranged on the external surface 1a1 of the tube, in order to roll on it substantially parallel to the axis 1a of said tube, while the jaws are in the closed position,
a remote-control power driving system 49 adapted for acting on the second part 15b, 15b1, 15b2 of the driving means, in order to drive the first part of said driving means, and therefore drive the scraping means 12, in rotation, while the first and second parts are in the inter-engaged position.

Preferably:
the powered control means 15b, 49, etc. will include a second series of wheels 51 (with axes of rotation 51a) mounted on the structure 110 and adapted to be arranged on at least one external rolling track 53a1 and/or 53a2 of the body 11 in order to roll on it (them), about the axis of the tube, while the jaws are in the closed position (cf FIGS. 2 and 4),
and the jaws will have smooth external surfaces, which are cylindrical when the jaws are in the closed position, and which then define said tracks 53a1 and/or 53a2, for the rolling of said second series 51 of wheels.

Most of the forces supported by the structure 110 will be transferred to the tube, via the wheels 47.

FIGS. 12 and 13 also show that the carriage is adapted to move in translation on the structure 110 by means of a connecting rod 48 powered by the power driving system 49 and that said carriage is coupled to return means 50 for replacing the meshed line of teeth 151b with the next teeth of the crown, once said line of teeth has reached the end of its course. As shown, the teeth 152 are not symmetrical in this case, but have a more marked slant on one side, so that the line of teeth 151b shifts in the direction opposite rotation A, when it reaches the end of its course, until it meshes again, once it has gone backward with enough engagement.

From FIGS. 4 and 5, it is also understood that the power driving system 49, which includes an electric motor 49a, is preferably separable from the structure 110, for example via two separable complementary square end parts 52b1, 52b2 provided respectively on parts 15b1 and 15b2 (see FIG. 4). The rotation of the motor 49a will thus be transformed into a translation of the carriage 43 by the connecting rod 48.

As shown in particular in FIG. 1, for a more compact and efficient structure, the jaws 13a, 13b preferably include, along the pivot pin 11a and arranged side-by-side, the crown 41 and at least one unit 55a1/55a2, which is also in two parts pivoting about said pin 11a, which unit internally bears at least some of the scraping means 12, in this case the blade 12a.

In the preferred version shown in FIG. 1, the externally toothed crown 41 is arranged coaxially between said two units 55a1/55a2 in two pivoting parts of which (at least) one bears said scraping means 12, on the internal surface, and the aforementioned rolling tracks 53a1 and/or 53a2 are defined on the external surface of said unit(s).

In this case, the two series of lateral wheels 51 of FIG. 2 roll respectively on one and the other of the tracks 53a1 and 53a2.

In this situation, the structure 110 is placed on the body 11, as shown in FIGS. 4 and 5, with the width L1 between the external lateral surfaces of the jaws (units 55a1/55a2; FIG. 1) being very slightly smaller than the width L2 between the internal surfaces of the lateral shoulders 57a1, 57a2 of this structure 110.

The lateral contact then produced between the internal surfaces of the lateral shoulders 57a1, 57a2 and the external lateral surfaces of the units 55a1/55a2 enables the force to be transmitted between the structure 10 and the body 11 and the aforementioned meshing to be kept in line.

Specifically, in order to move the scraping means in a spiral around the tube and as shown in FIG. 5:
each axis 19a of rotation of the rolling means 19 of the body 11 is oriented slightly at an angle with respect to the pivot pin 11a or the axis 1a of the tube,
and the lateral component of the force created by the rotation of the device about the tube therefore passes between the structure 10 and the body 11 by means of the contact between the surfaces and the shoulders 55a1/55a2, 57a1/57a2, thus defining stop means.

A single blade 12 can be mounted on one of the lateral units 55a1/55a2.

Alternatively (not shown), each of the two pivoting lateral units 55a1/55a2 between which the externally toothed crown 41 extends coaxially may bear one of said scraping means, on the internal surface.

In particular in this last case, the units 55a1/55a2 may also be mounted so as to move one with respect to the other parallel to the pivot pin 11a of the jaws, so as to adjust the length to be grated. Parallel guide bars may in this case extend between them and a holding system (nut, pin, etc.) will adjustably set the distance (version not shown).

1. A tube scraping device including:
a body adapted to rotate about a pivot pin to be arranged parallel to an axis of the tube to be scraped, said body having two jaws adapted to rotate about said pivot pin between:
an open position enabling the body to be disposed around the tube and removed therefrom;
a closed position in which the jaws are closer to the tube than in the open position, said jaws including a first part of driving means adapted to drive said jaws in rotation about the tube while the jaws are in the closed position, and said body holding jaw maneuvering means, for moving said jaws from the open position to the closed position, and the reverse, and tube scraping means adapted to come into contact with an external surface of said tube with a view to scraping it, while said jaws are in the closed position, the scraping means being mounted so as to rotate with the body, and therefore with the jaws,
a second part of the driving means, said second part being adapted for engaging with the first part said driving means, with a view to causing, in an engaged position, said rotation of the jaws,
and rolling means mounted at an internal surface of the jaws, away from the scraping means, so as to cause said jaws to roll around an external surface of the tube, while said jaws are in the closed position.

2. The device according to claim 1, wherein said jaw maneuvering means include toggle means adapted to act in coordination with spring means for pivoting the jaws between said open and closed positions.

3. The device according to claim 1, wherein said jaw maneuvering means include aid means for aiding the closing of the jaws, said aid means including two actuation members which are:
respectively attached to one and the other of said jaws, each actuation member having a nose projecting from said internal surface of the jaws, while said jaws are in the open position, and
located so that two opposing closing torques are created, by the contact of the noses on the tube.

4. The device according to claim 2, wherein the toggle means include two levers:
that are each pivotably connected to one of the jaws,
and to which a maneuvering end part is pivotably connected, said maneuvering end part being removably attached to a rod for a remote control of the opening and of the closing of the jaws, respectively by pulling and pushing on the toggle means.

5. The device according to claim 1, wherein the second part of the driving means is separable from the first part thereof and belongs to manual control means including a structure bearing said second part of the driving means and an elongate rod pivotably mounted on said structure, so that it can be pushed, while the first and second parts of the driving means are in the inter-engaged position, so as to move one with respect to the other and thus drive said scraping means around the tube.

6. The device according to claim 1, wherein the second part of the driving means is separable from said first part and belongs to powered control means including:
a structure bearing said second part of the driving means,
a first series of wheels to be arranged on the external surface of the tube, in order to roll on it substantially parallel to the axis of said tube, while the jaws are in the closed position,
a remote-control power driving system adapted to act on the second part of the driving means, in order to drive the first part of said driving means, and therefore drive the scraping means, in rotation, while said first and second parts of the driving means are in the inter-engaged position.

7. The device according to claim 1, wherein the first and second parts of the driving means define a toothed driving system in which said parts mesh with one another.

8. The device according to claim 6, wherein:
the powered control means include a second series of wheels adapted to be arranged on at least one external rolling track of the body in order to roll on it, about the axis of the tube, while the jaws are in the closed position, and
said jaws have smooth external surfaces which are cylindrical when the jaws are in the closed position, and which then define said tracks, for the rolling of said second series of wheels.

9. The device according to claim 1, wherein the first part of said driving means include a crown having two externally toothed parts pivotably connected one with respect to the other around said pivot pin.

10. The device according to claim 9, wherein, along the pivot pin, the jaws include, arranged side-by-side, said crown and at least one unit which is in two parts pivoting about said pivot pin, which unit internally bears at least some of means.

11. The device according to claim 8, wherein:
along the pivot pin, the jaws include, arranged side-by-side, said crown and two units, each of which is in two parts pivoting about said pivot pin, which unit internally bears at least some of the scraping means, and,
said crown is arranged coaxially between said two units, at least one of said two pivoting parts of which bears the scraping means, on an internal surface thereof, and one external rolling track is defined on the external surface of said units.

12. The device according to claim 1, wherein:
rolling means are mounted on the internal surface of the jaws so as to cause them to roll around the external surface of the tube, while the jaws are in the closed position,
each rolling means having an axis of rotation oriented slightly at an angle with respect to the pivot pin,
and a part of the force created by the rotation of the structure about the tube passes between said structure and the body by means of a lateral contact, thus ensuring that the scraping means are driven in a spiral.
